(19) United States
(12) Patent Application Publication
(10) Pub. No.: US 2012/0191493 A1
(43) Pub. Date: Jul. 26, 2012

(54) DETERMINING TECHNOLOGY COSTS ASSOCIATED WITH A FINANCIAL PRODUCT

(75) Inventor: Timothy McCourt, Charlotte, NC (US)

(73) Assignee: BANK OF AMERICA CORPORATION, Charlotte, NC (US)

(21) Appl. No.: 13/011,319

(22) Filed: Jan. 21, 2011

(51) Int. Cl. G06Q 10/00; G06Q 40/00

(52) U.S. Cl. 705/7.11

(57) ABSTRACT

The present invention provides for methods, apparatus and computer programs for determining technology costs associated with a financial product, and, in specific embodiments, an equity trade. In specific embodiments of the invention the technology application costs may be determined on a per-process basis and subsequently totaled to determine the overall cost. The invention provides for identifying a plurality of processes and a plurality of technology applications each of which are associated with a financial product. Once the processes and technology application have been identified, process allocation percentages are determined for each of the technology applications and identified processes associated with each of the technology applications and a per-financial product technology cost for each of the plurality of technology applications is determined over a predetermined time period. Additionally, the per-process technology cost is determined for the financial product based on the per-financial product technology cost for each of the plurality of technology applications and the process allocation percentages associated with a respective process and a respective technology application.

### FIELD

In general, embodiments of the invention relate to assessing business costs and, more particularly, determining technology costs associated with a financial product, for example, an equity trade.

### BACKGROUND

Currently, businesses and, more specifically, financial institutions have ongoing initiatives directed toward understanding the costs associated with specific products. By better understanding the costs associated with a financial product, the financial institution can, using revenue and net income data, better understand the profitability associated with the product. Such analysis further provides for prioritization of the greatest opportunities for expense reduction and net income optimization.

Accordingly, there is a need for methods, systems and computer program products for determining cost, specifically, technology application costs associated with a financial product. Specifically, there is a need to determine technology application costs associated with equity trades. Equity trade technology cost analysis and breakdown is specifically necessary since a high percentage of technology and operations costs associated with global markets are typically charged to equities. The desired cost determining model should determine cost for all technology processes and applications across the entire equity trade, including front end, operations, middle office, front-to-back end (e.g., trade capture, documentation, settlement, finance and the like). In addition the desired costing model should be capable of aligning with a comprehensive corporation or enterprise-wide system determining and managing costs and/or business rigor.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Thus further details are provided below for determining technology costs associated with financial products and, specifically, equity trades. Embodiments herein disclosed further provide for determining technology costs on a per-process basis and subsequently summing

A method for determining per-process technology costs for a financial product defines first embodiments of the invention. In specific embodiments the financial product may be a financial trade product and, more specifically, an equity trade product. The method includes identifying a plurality of processes and a plurality of technology applications each of which are associated with a financial product. The method further includes determining process allocation percentages for each of the identified technology applications and processes associated with each of the technology applications. Additionally, the method includes determining a per-financial product technology cost for each of the plurality of technology applications over a predetermined time period. Moreover, the method includes determining the per-process technology application cost for the financial product based on the per-financial product technology cost for each of the plurality of technology applications and the process allocation percentages associated with a respective process and a respective technology application.

In specific embodiments of the method, determining process allocation percentages further includes mapping the plurality of processes to each of the plurality of technology applications to assess the process allocation percentages.

In further specific embodiments of the method, determining the per-financial product technology cost includes determining total technology cost for each of the plurality of technology applications. The total technology cost for each of the plurality of technology applications accounts for entity-wide costs. In such embodiments, the determining total technology cost further includes receiving core costs, administrative costs and infrastructure costs for each of the plurality of technology applications and summing the core costs, the administrative costs and infrastructure costs for each of the plurality of technology applications to result in the total technology cost for each of the plurality of technology applications.

In further embodiments of the method, determining the per-financial product technology cost may further include determining financial product allocation percentages for each of the technology applications and financial products associated with each of the technology applications. In such embodiments of the method determining the per-financial product technology cost may further include calculating a per-financial product technology cost for each technology application by multiplying the total technology cost of each of the plurality of technology applications by the financial product allocation percentage associated with a respective financial product.

In still further embodiments of the method, determining per-process technology cost further includes calculating a per-process technology cost by multiplying the per-financial product technology cost for each of the plurality of technology applications by the process allocation percentage associated with the process and the technology application.

In other embodiments the method included determining a volume of financial products occurring over the predetermined time period. In such embodiments, the method further includes determining a financial product technology unit cost based on the volume and/or determining a per-process technology cost per financial product unit based on the volume. In such embodiments of the method, determining per-process technology cost per financial product unit further includes calculating the per-process technology cost per financial product unit by dividing the per-process technology cost by the volume.

An apparatus for determining per-process technology cost for a financial product defines second embodiments of the invention. In specific embodiments the financial product is a financial trade and, more specifically, an equity trade. The apparatus includes a computing platform including at least one processor and a memory. The apparatus further includes a financial product technology cost determining module stored in the memory and executable by the processor. The module includes a technology cost determining routine configured to determine a per-financial product technology cost for each of a plurality of technology applications. The per-financial product technology cost is incurred over a predetermined time period. The module further includes a per-process technology cost determining routine configured to determine the per-process technology cost for the financial product based on the per-financial product technology cost for each of the plurality of technology applications and a process allocation percentage associated with a respective process and one of the technology applications.

In further embodiments of the apparatus, the technology cost determining routine is further configured to determine a total technology cost for each of the plurality of technology applications. The total technology cost for each of the plurality of technology applications accounts for entity-wide costs. In such embodiments, the technology cost determining routine is further configured to receive core costs, administrative costs and infrastructure costs for each of the plurality of technology applications and sum the core costs, administrative costs and infrastructure costs to result in the total technology cost for each of the plurality of technology applications.

In further embodiments of the apparatus, the technology cost determining routine is further configured to determine the per-financial product technology cost based on a financial product allocation percentage associated with a respective financial product and one of the technology applications. In such embodiments of the apparatus, the technology cost determining routine is further configured to calculate the per-financial product technology cost for each technology application by multiplying the total technology cost for each of the plurality of technology applications by the financial product allocation percentage associated with a respective financial product and a respective technology application.

In still further embodiments of the apparatus, the per-process technology cost determining routine is further configured to calculate the per-process technology cost by multiplying the per-financial product technology cost for each of the plurality of technology applications by the process allocation percentage associated with a respective financial product process and one of the technology applications.

In further embodiments of the apparatus, the financial product technology cost determining module further includes a financial product unit cost determining routine configured to determine financial product unit technology cost based on a volume of financial products occurring over the predetermined time period. In such embodiments, the financial product unit cost determining routine if further configured to determine per-process technology cost per financial product unit. In such embodiments of the apparatus, the financial product unit cost determining routine is further configured to calculate per-process technology cost per financial product unit by dividing the per-process technology cost by the volume of financial products occurring over the predetermined time period.

A computer program product that includes a non-transitory computer-readable medium defines third embodiments of the invention. The computer-readable medium includes a first set of codes for causing a computer to determine a per-financial product technology cost for each of a plurality of technology applications associated with a financial product. The per-financial product technology cost is over a predetermined period of time. The computer-readable medium additionally includes a second set of codes for causing a computer to determine a per-process technology cost for the financial product based on the per-financial product technology cost for each of the plurality of technology applications and process allocation percentages associated with a respective process and a respective technology application.

Thus, present embodiments, described below in further detail, provides for determining cost, specifically, technology application costs associated with a financial product, such as equity trades. The cost determining model herein described determines cost for all technology processes and applications across the entire equity trade, including front end, operations, middle office, front-to-back end (e.g., trade capture, documentation, settlement, finance and the like). As such, the determined cost provides a complete picture of the economic impact of the equity trade. In addition the costing model herein described is capable of aligning with a comprehensive corporation or enterprise-wide system that determines and manages costs and/or business rigor.

### FIGURES

FIG. 1 is a block diagram depiction of an apparatus configured to determine per-process technology costs for a financial product in accordance with embodiments of the present invention.

FIG. 2 is a flow diagram of a method for determining per-process technology costs for a financial product in accordance with embodiments of the present invention.

FIG. 3 is a block diagram depiction of processes mapped for an equity trade in accordance with an embodiment of the present invention.

FIGS. 4A and 4B are a spreadsheet for determining per-process technology costs for an equity trade in accordance with embodiments of the present invention.

FIG. 5 is a flow chart of an exemplary process for managing business rigor in accordance with an embodiment of the present invention.

FIG. 6 is a flow chart of an exemplary process for developing business management rigor and routines in accordance with an embodiment of the present invention.

FIG. 7 is an example of a Function, Activity and Time (“FAT”) table in accordance with an embodiment of the present invention.

FIG. 8 is an example of a supply table of the FAT table in accordance with an embodiment of the present invention.

FIG. 9 is a flow chart of an exemplary process for generating a unit cost report (“Phone Bill”) in accordance with an embodiment of the present invention.

FIGS. 10a and 10b (collectively FIG. 10) is an example a Phone Bill in accordance with an embodiment of the present invention.

FIGS. 11a and 11b (collectively FIG. 11) is an example of a key indicator scorecard (KIS) in accordance with an embodiment of the present invention.

FIG. 12 is a block schematic diagram of an example of an apparatus for managing business rigor in accordance with an embodiment of the present invention.

### DETAILED DESCRIPTION

Embodiments of the present invention are described below with reference to flowchart illustrations and/or block diagrams of methods and apparatuses (systems, computer program products, devices, etc.). It will be understood that each event of the flowchart illustrations and/or block of block diagrams, and/or combinations of events in the flowchart illustrations and/or blocks in the block diagrams, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block/event or blocks/events.

These computer program instructions may also be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any medium that can contain, or store a program for use by or in connection with an instruction execution system, apparatus, or device.

A computer-readable signal medium may include a propagated data signal with computer program instructions embodied therein, for example, in base band or as part of a carrier wave. Such a propagated signal may take any of a variety of forms, including, but not limited to, electro-magnetic, optical, or any suitable combination thereof. A computer-readable signal medium may be any computer-readable medium that can contain, store, communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, radio frequency (RF), etc.

The computer program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart events and/or block diagram block(s). Alternatively, computer program implemented steps or acts may be combined with operator or human implemented steps or acts in order to carry out an embodiment of the invention.

Embodiments of the present invention may take the form of an entirely hardware embodiment, an entirely software embodiment (including firmware, resident software, micro-code, etc.) or an embodiment combining software and hardware aspects that may all generally be referred to herein as a “module,” “apparatus,” or “system.”

It should be understood that terms like “bank,” “financial institution,” and just “institution” are used herein in their broadest sense. Institutions, organizations, or even individuals that process loans are widely varied in their organization and structure. Terms like “bank” and “financial institution” are intended to encompass all such possibilities, including but not limited to, finance companies, stock brokerages, credit unions, mortgage companies, insurance companies, companies other than financial companies/banks, etc. Additionally, disclosed embodiments may suggest or illustrate the use of agencies or contractors external to the financial institution to perform some of the calculations and data repository services. These illustrations are examples only, and an institution or business can implement the entire invention on its own computer system(s) or even a single work station if appropriate databases are present and can be accessed.

Embodiments of the present invention relate to methods, apparatus, systems and computer program products for determining technology application costs associated with financial products and, specifically, financial trades, such as equity trades or the like. Embodiments herein disclosed further provide for determining technology application costs on a per-process basis and subsequently summing

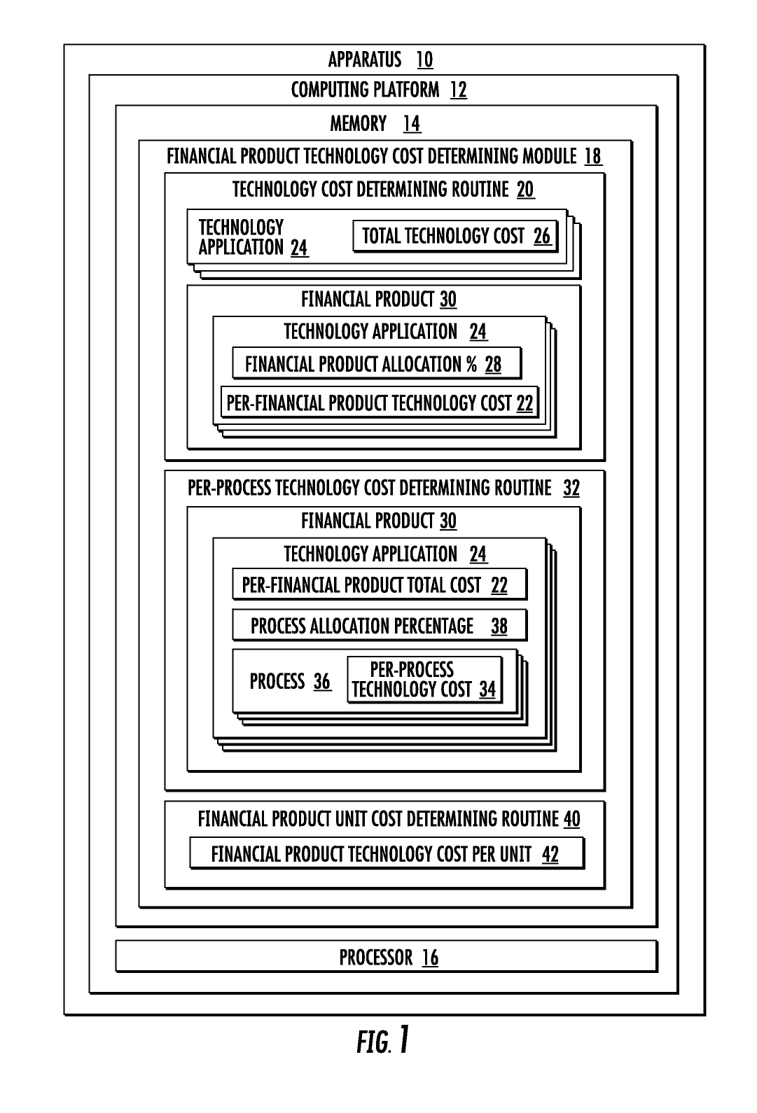

FIG. 1 is a block diagram of an apparatus 10 configured to determine per-process technology costs associated with a financial product. As defined herein, a financial product includes any product or service offered by a financial institution, bank or the like. In specific embodiments of the invention the financial product is a financial trade and, more specifically, an equity trade.

The apparatus 10 includes a computing platform 12 having a memory 14 and a processor 16 in communication with the memory 14. The memory 14 of apparatus 10 stores financial product technology cost determining module 18, which is executable by processor 16 and configured to determine technology costs associated with financial products.

Financial product technology cost determining module 18 includes technology cost determining routine 20 configured to determine a per-financial product total technology cost 22 for each of a plurality of technology applications 24. The per-financial product total technology cost 22 is determined for a predetermined time period, such as an annual period or the like.

In specific embodiments of the apparatus, technology cost determining routine 20 initially determines a total technology cost 26 (i.e., entity-wide) for each of the plurality of technology applications. In such embodiments, the technology cost determining routine 20 may be configured to receive or, otherwise assess, core costs, administrative costs and infrastructure costs associated with each of the plurality of technology applications and sum the core costs, administrative costs and infrastructure costs to result in a total technology cost 26 for each of the plurality of technology applications 24.

The technology cost determining routine 20 may be further configured to determine the per-financial product total technology cost 22 based on a financial product allocation percentage 28 determined or otherwise assigned to each of the plurality of technology applications 24 as it pertains to the financial product 30 of note (i.e., the financial product undergoing technology cost assessment). The financial product allocation percentage 28 is the percentage of overall entity utilization of the technology application attributable to the financial product 30 of note.

The financial product technology cost determining module 18 additionally includes per-process technology cost determining routine 32 configured to determine the per-process technology cost 34 for each process 36 associated with the financial product 30 based on the per-financial product technology cost 22 for each applicable technology application 24 and a process allocation percentage 38 determined or otherwise assigned to each of a plurality of processes 36 associated with the financial product 30. The process allocation percentage 38 is the percentage utilization of a specified technology application 24 for a particular process 36 associated with the financial product 30.

The financial product technology cost determining module may optionally include financial product unit technology cost determining routine 40 configured to determine financial product unit technology cost 42. In specific embodiments of the invention the financial product unit technology cost 42 is determined by dividing an overall technology cost for the financial product by a volume of financial products occurring over the predetermined time period. In other embodiments of the invention the unit cost may be further broken down by process. In such embodiment, a per-process technology cost per financial product unit may be calculated by dividing the per-process technology application cost 34 by a volume of financial products occurring over the predetermined time period.

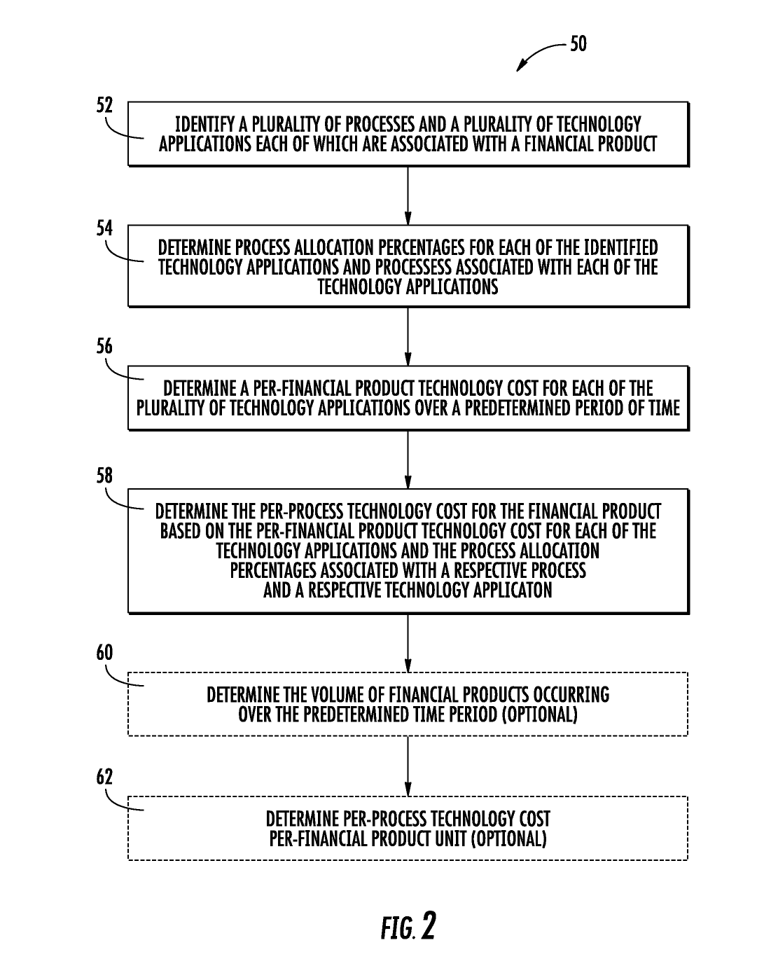

FIG. 2 is a flow diagram of a method 50 for determining per-process technology costs for a financial product, in accordance with embodiments of the present invention. As previously noted, in specific embodiments of the invention the financial product is a financial trade and, more specifically, an equity trade.

At Event 52, a plurality of processes and a plurality of technology applications, each of which are associated with a financial product, are identified. Specifically, identification of processes associated with the financial product and technology applications associated with the financial product may provide for relevant process mapping and technology application mapping to occur to accurately assess which processes and technology applications are relevant to the financial product.

At Event 54, process allocation percentages are determined for each of the identified technology applications and processes associated with each of the technology applications. In specific embodiments, process allocation percentages may be determined by mapping the plurality of identified processes to each of the plurality of identified technology applications prior to determining or assessing process allocation percentages. While in some embodiments the process allocation percentages may be manually assigned based on data assessment, in other embodiments the process allocation percentages. The process allocation percentage is the percentage utilization of a specific technology application for a particular process associated with the financial product.

At Event 56, a per-financial product technology cost is determined for each of the plurality of technology applications. The per-financial product technology cost is determined for a predetermined time period, such as an annual period or the like.

In specific embodiments of the method, determining the per-financial product technology cost includes determining a total technology cost (i.e., entity-wide) for each of the plurality of technology applications. In such embodiments, the total technology cost technology may be determined by receiving or, otherwise assessing, core costs, administrative costs and infrastructure costs associated with each of the plurality of technology applications and summing the core costs, administrative costs and infrastructure costs to result in a total technology cost for each of the plurality of technology applications. In such embodiments the method may further include determining the per-financial product technology cost based on a financial product allocation percentage. In such embodiments the method may include determining, or otherwise assessing, the financial product allocation percentage for each of the plurality of technology applications as it pertains to the financial product of note (i.e., the financial product undergoing technology cost assessment). The financial product allocation percentage is the percentage of overall entity utilization of the technology application attributable to the financial product of note. In such embodiments, determining the per-financial product technology cost includes multiplying the financial product allocation percentage by the total technology cost for each of the technology applications.

At Event 58, per-process technology costs for the financial product are determined based on the per-financial product technology cost for each of the technology applications and the process allocation percentages associated with a respective process and a respective technology application. In specific embodiments of the method, the per-process technology costs are calculated by multiplying the per-financial product technology costs for each of the plurality of technology applications by the process allocation percentage associated with the corresponding process and the technology application.

At optional Event 60, the volume of financial products occurring over the predetermined time period is determined, or otherwise received, For example, the volume of equity trades occurring over a predetermined time period, such as a month, six months a year or the like. The volume of financial products occurring over a predetermined period provides for determining a financial product technology unit cost based on the volume.

At optional Event 62, a per-process technology cost per financial product unit is determined. In specific embodiments of the method, the per-process technology cost is determined by dividing the per-process technology cost by the volume of the financial products occurring over the predetermined time period.

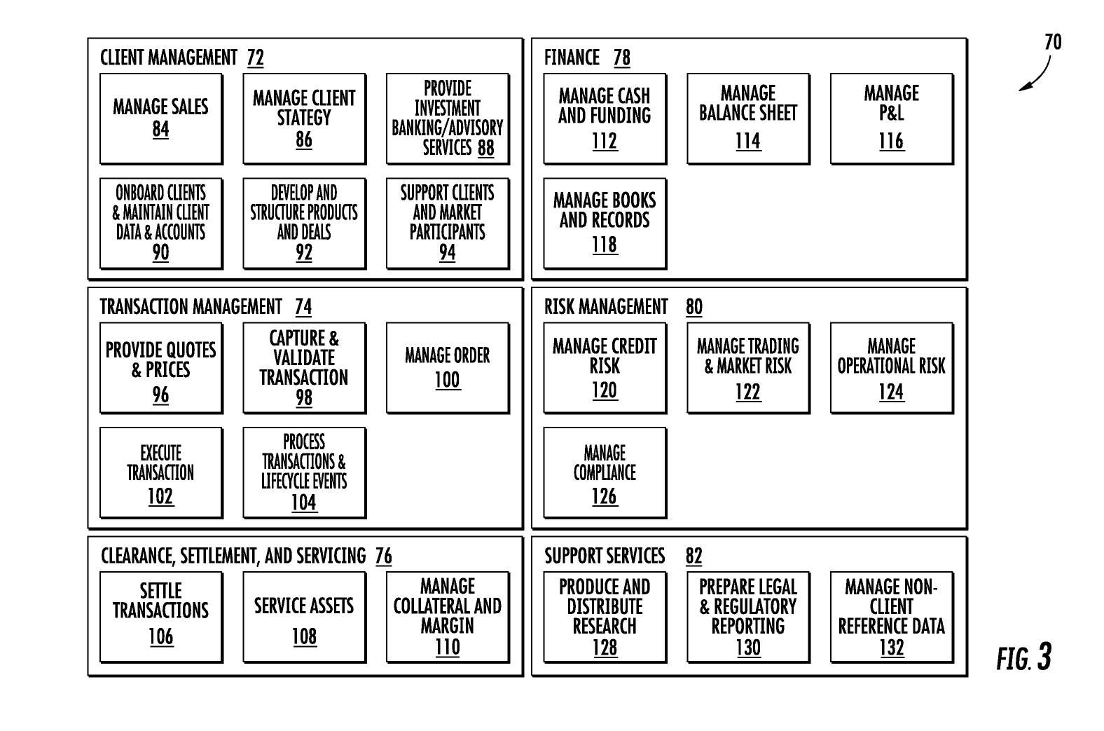

Referring to FIG. 3 a block diagram 70 is depicted of high level processing mapping of a financial product, specifically an equity trade. It should be noted that the results of the process mapping shown here are by way of example only and, as such, other process maps of financial products, and specifically equity trades, are contemplated and within the inventive concepts herein disclosed. The mapping of the equity trades processes has identified for six highest level process categories; client management 72; transaction management 74; clearance, settlement and servicing 76; finance 78; risk management 80 and support services 82. Each of the highest level process categories include one or more processes. Specifically, client management 72 includes processes for managing sales 84; managing client strategy 86; providing investment banking/advisory sales 88; onboarding clients and maintaining client data/accounts 90; developing and structuring products and offers 92; and supporting clients and market participants 94.

Transaction management 74 includes processes for providing quotes and prices 96; capturing and validating transactions 98; managing orders 100; executing transactions 102 and processing transactions and lifecycle events 104. Clearance, settlement and servicing 76 includes processes for settling transactions 106; servicing assets 108; and managing collateral and margin 110. Finance 78 includes processes for managing cash and funding 112; managing balance sheet 114; managing profits and losses 116; and managing books and records 118.

Risk management 80 includes processes for managing credit risk 120; managing trading and market risk 122; managing operational risk 124; and managing compliance 126. Support services 82 includes processes for producing and distributing research 128; preparing legal and regulatory reporting 130; and managing non-client reference data 132.

The processes shown in FIG. 3 may be further mapped to sub-processes. In such embodiments of the invention in which sub-process are identified, per-process technology costs may include sub-process technology costs in the event that technology applications can be associated with the sub-processes and sub-process allocation percentages can be quantified.

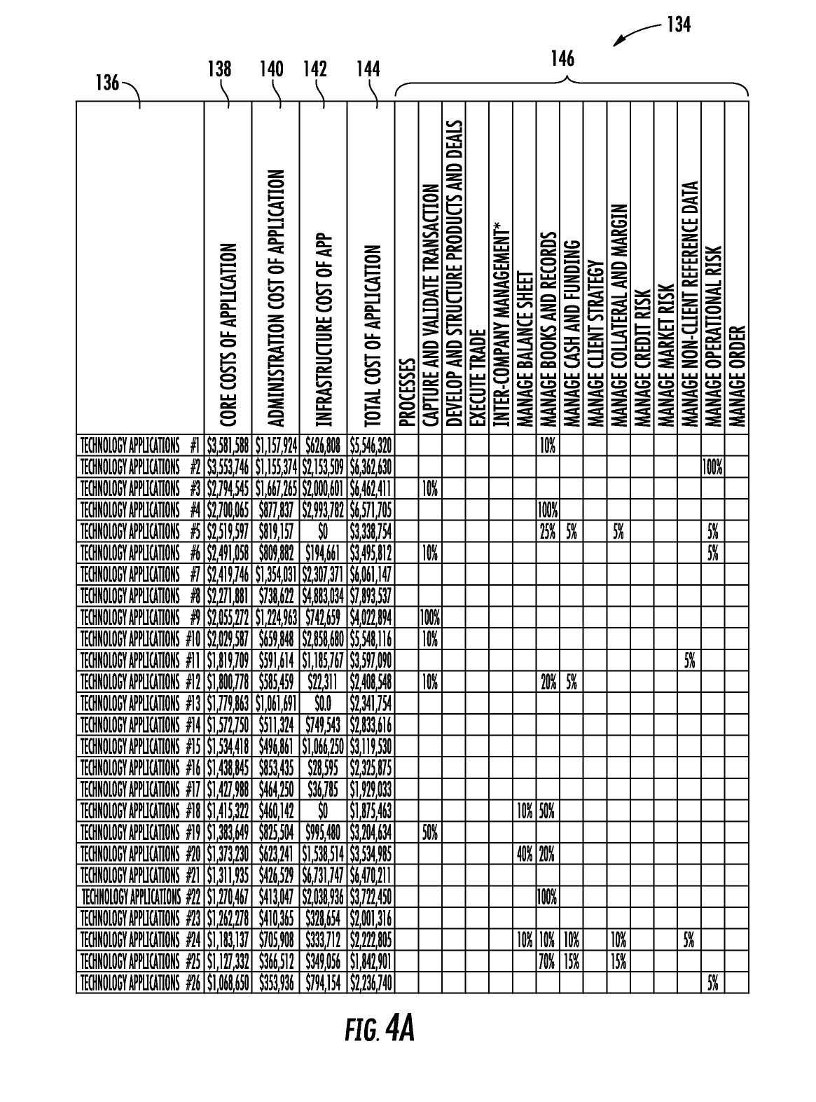

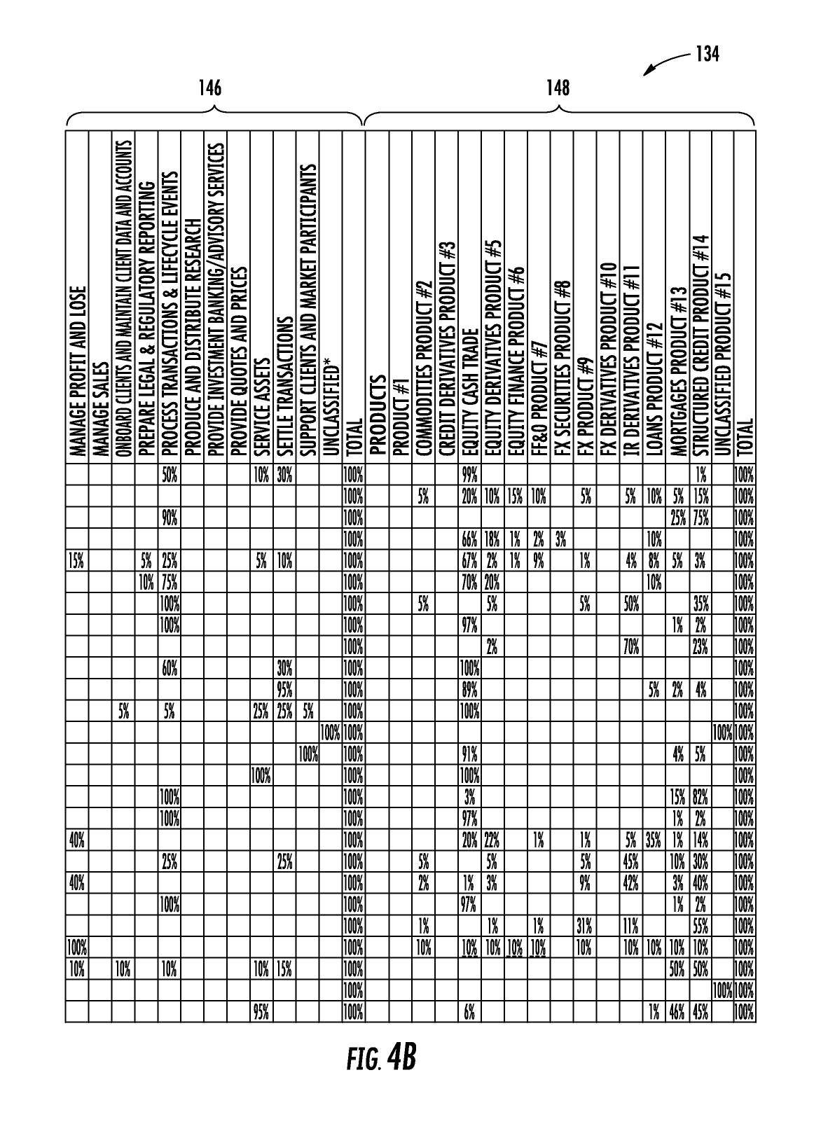

Turning the reader's attention to FIGS. 4A and 4B a spreadsheet-type application 134 is depicted for managing the technology cost determination for a financial product, specifically, an equity trade, in accordance with embodiments of the present invention. The left-most column of spreadsheet 134 provides for a technology application listing 136, which lists the technology applications that have been identified as associated with equity trades. While the technology applications are depicted as technology application Nos. 1-26, in practice the actual name of the technology application, as well as, an alphanumeric identifier may be listed in the technology application listing 136.

Moving right from the left-most column of spreadsheet 134, the next four columns represent entity-wide cost data associated with each of the technology applications. Specifically, core costs 138 associated with the application, administrative costs 140 associated with the application, infrastructure costs 142 associated with the application and the total technology cost 144 of the application (i.e., the sum of the core, administrative and infrastructure costs). The cost data shown accounts for a predetermined time period, for example, a month, six months, a year or the like. The entity-wide cost data associated with the technology applications may be imported from other databases within the entity.

Moving right from the cost data columns 138-144, the next series of columns represent the processes 146 previously shown and described in relation to the block diagram of FIG. 3. The process columns 146 provide for entry of process allocation percentages. The entry of the process allocation percentages may be empirically derived and either automatically or manually inputted or imported into the spreadsheet. As previously noted, process allocation percentages are defined as the percent utilization of a specified technology application for a particular process associated with the financial product, in this example, an equity trade. As shown in the spreadsheet 134, the cumulative process allocation percentages for each technology application equals one-hundred percent. It is also noted that the spreadsheet 134 provides for entry of an unclassified process allocation percent (i.e., the column preceding the total process allocation column) in instances in which process allocation percentage is not or can not be assessed or derived.

The right-most columns represent the various products/services 148 offered by the entity. The product/service columns 148 provide for entry of financial product allocation percentages. The entry of the financial product allocation percentages may be empirically derived and either automatically or manually inputted or imported into the spreadsheet As previously noted, financial product allocation percentages are defined as the percent utilization of a specified technology application for a particular financial product. The use of a technology application is not typically limited to one particular financial product and, therefore, the financial product allocation percentage is required to determine the technology costs specific to the financial product. As shown in the spreadsheet 134, the cumulative financial product allocation percentages for each technology application equals one-hundred percent. It is also noted that the spreadsheet 134 provides for entry of an unclassified financial product allocation percent (i.e., the column preceding the total process allocation column) in instances in which financial product allocation percentage is not or can not be assessed or derived.

Once the equity trade allocation percentages have been inputted in the corresponding process column 148, the per-equity trade technology cost for each technology application can be determined by multiplying the applicable equity trade allocation percentage by the total cost of the technology application. In addition, once the process allocation percentages have been inputted, the per-process technology cost for each technology application can be determined by multiplying the applicable process allocation percentage by the per-financial product technology cost. Once the per-process technology costs have been determined and the volume of equity trades occurring during the predetermined time period have been determined, the equity trade unit technology cost can be determined by dividing the equity trade technology cost by the volume of equity trades.

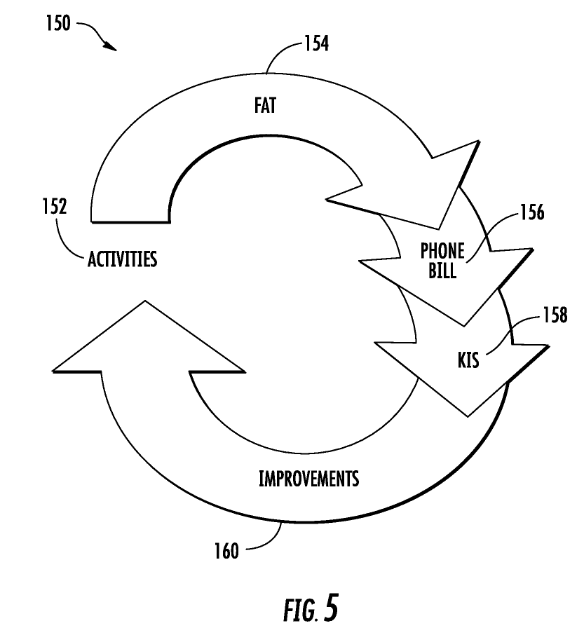

FIG. 5 is flow diagram depiction of a system managing business rigor 150 in a company, such as a financial institution. The system shown and described in FIGS. 5-12 is one example of a system that may benefit from technology cost determination of financial products and, more specifically, financial trades, such as equity trades or the like. The reader should note that the system shown in described in FIGS. 5-12 should not be construed as limiting to the technology cost determining methods, apparatus and computer program products shown and described in FIGS. 1-4. Other systems for managing business and/or business rigor may also be implemented in conjunction with the present invention without departing from the inventive concepts herein disclosed.

In one embodiment, business rigor relates to the resources employed in a financial institution, such as costs, employee capacity and utilization, unit volumes, value of products, capability, etc. Such business rigor can be built, measured, and managed for continuous improvement by using the methodology described herein for capacity, unit cost, and risk measurement and management. As such, business rigor is an operational part of the business being operated on a cost effective basis. The below-described systems and methods detail measurement and management of such business rigor by using various tools, including a performance template (or a Function, Activity, and Time (“FAT”) template), a unit cost report (“Phone Bill”), and a summary report (or a Key Indicator Scorecard (“KIS”)).

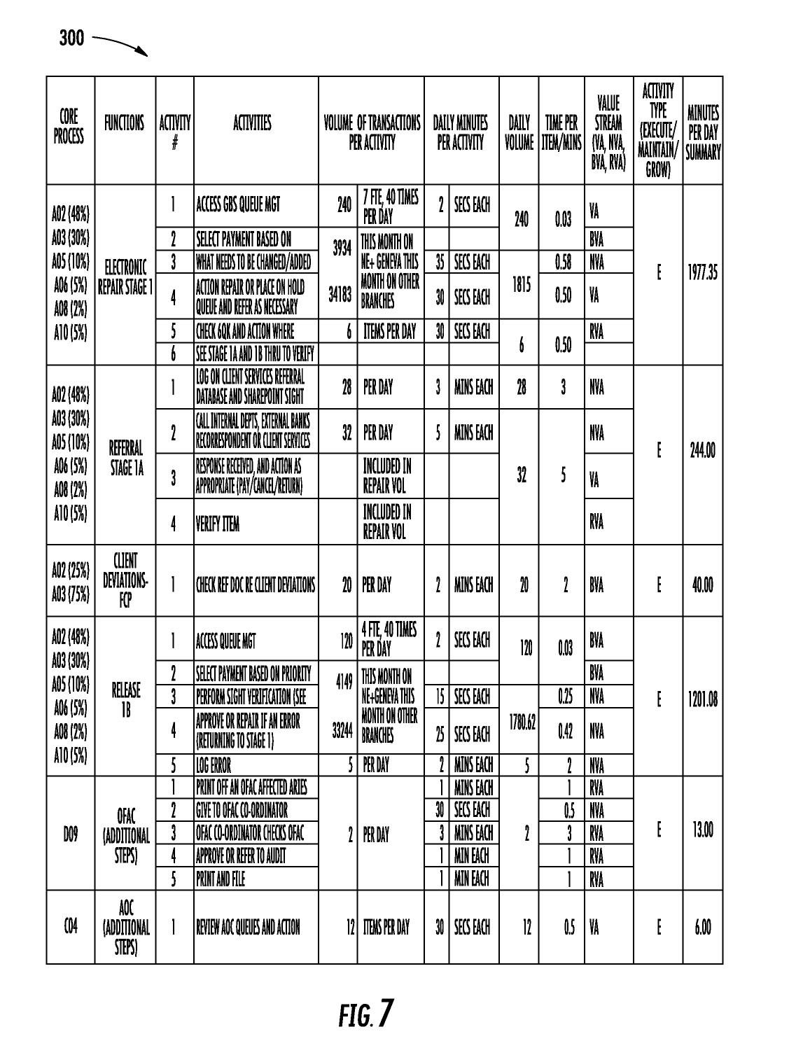

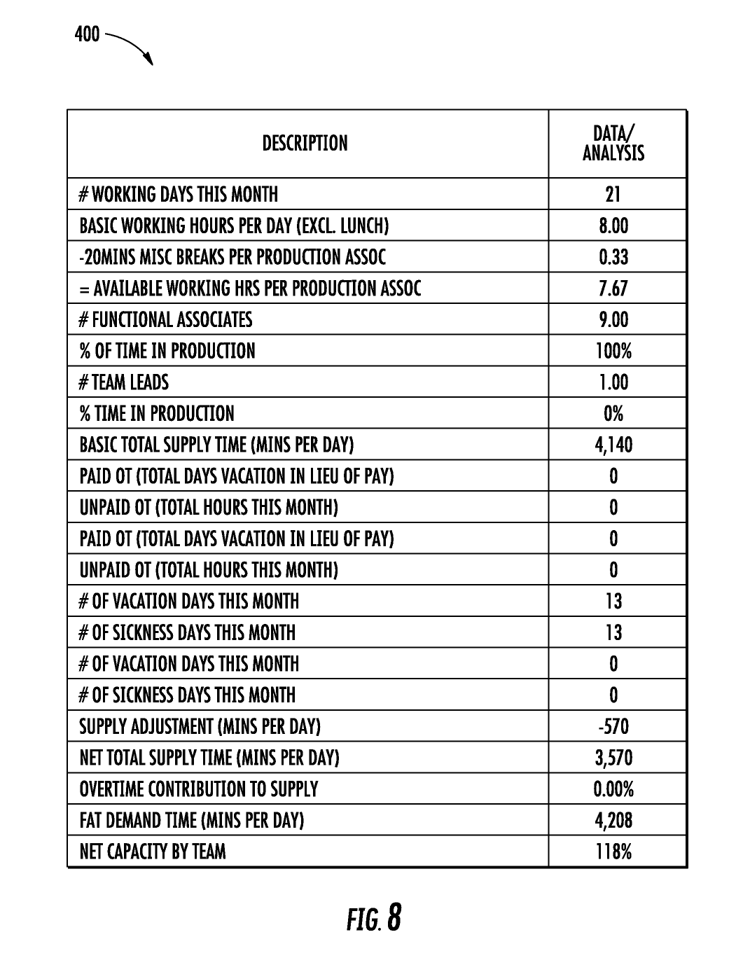

FIG. 5 is a flow chart of an example for managing business rigor 150 in accordance with an embodiment of the present invention. The flow chart illustrates a process for managing business rigor 150 in a company, such as a financial institution. As illustrated, daily activities or tasks 152 are performed by various representatives of the financial institution. Data related to these activities is captured and recorded along with the associated transaction volumes in the FAT table 154. The FAT table 154 is discussed in more depth below with regards to the discussion of FIGS. 7-8. After the FAT table 154 is established, the data in the FAT table 154 is used to develop a reporting of unit costs (“Phone Bill”) 156. Additionally, the data from the FAT 154 and the Phone Bill 156 are employed to create the KIS 158, for current processes and risks. The data in the FAT table 154, Phone Bill 156, and KIS 158 are reviewed by associates, managers and key process owners to identify process improvement opportunities 110 such as cost cutting measures and other opportunities.

The flow chart 150 of FIG. 5 further illustrates a continuous improvement feedback loop 160 such that the above processes continually improve the end-to-end workflow and management of resources of the financial institution. This continuous loop facilitates ongoing improvement of the processes, work, and customer servicing for various departments/divisions within the financial institution, such as sales, products, risks, finance, client service, technology, and supply chain. This is due to the integration of the business management across the various departments/divisions of the company, instead of only a single department/division. Each of the FAT table 154, Phone Bill 156 and KIS 158 are described in more depth with regard to FIGS. 7-12.

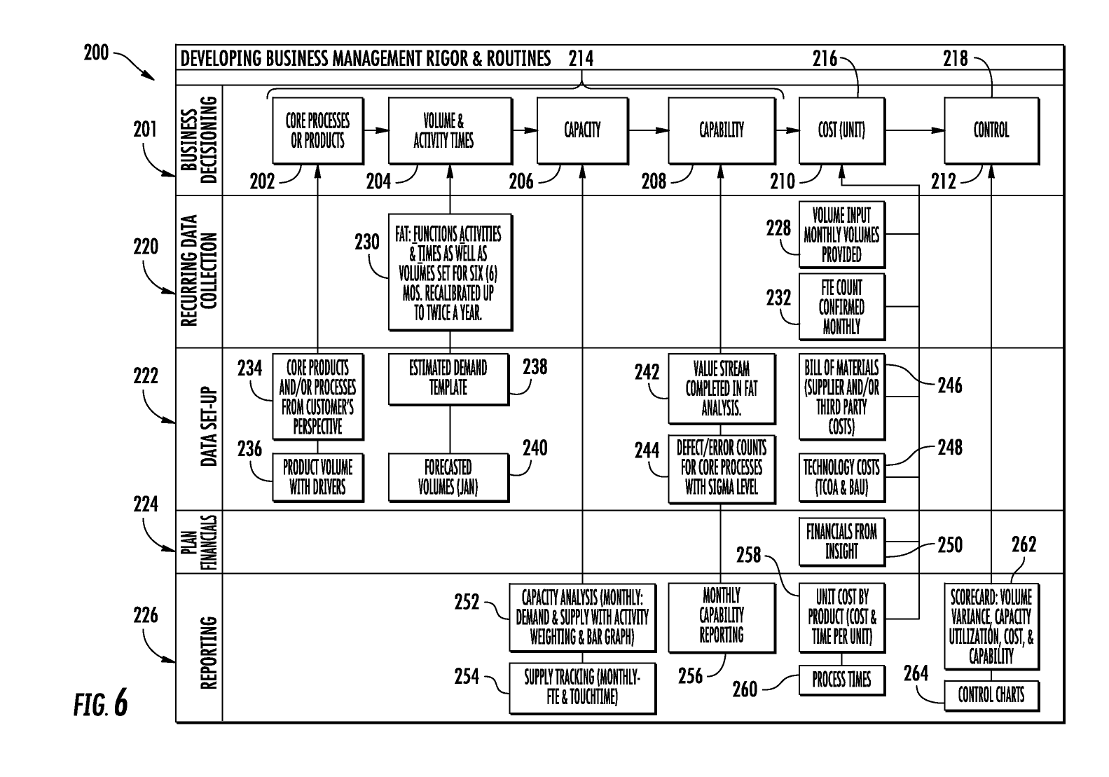

FIG. 6 is a flow chart 200 of an example for developing business management rigor and routines in accordance with an embodiment of the present invention. As illustrated, various business decisioning 201 refers to a category of processes where the business may make decisions instrumental to improving business rigor. The processes in the business decisioning 201 category of FIG. 6 include “Core Products” 202, “Volume and Activity Times” 204, “Capacity” 206, “Capability” 208, “Unit Costs” 210, and “Control” 212. The “Core Products” 202, “Volume and Activity Times” 204, “Capacity” 206, “Capability” 208″ are associated with the FAT table 214; the “Unit Cost” process 210 relates to the Phone Bill 216; and the “Control Process” 212 relates to the KIS 218. Each of these processes is described later with respect to the discussion of the FAT, Phone Bill and KIS, respectively.

Other than the business decisioning 201 category of the flow chart 200 of FIG. 6, other processes in FIG. 6 are categorized as recurring data collection 220, data set-up 222, planning financials 224, and reporting 226. The recurring data collection 220 process relates to collecting data about the business, such as volume data 228, FAT data 230, full-time employee (FTE) information 232 and other data recurring periodically which may be collected.

The data-set up category 222 in FIG. 6 relates to data which may be inputted to set up data collection and inputs required to make business decisioning, such as inputting core products and/or processes 234, product volume with drivers 236, estimated employee demand template 238, forecasted volumes 240, value stream analysis 242, defect/error counts for core products 244, bill of materials (BOM) costs 246, technology costs 248, and other information which may be inputted or set-up.

The planning financials category 224 of FIG. 6 may relate to any information related to planning out projected, estimated and/or current financial information of the business. For example, financial information 250 may be inputted which may include current financial numbers of each core product/process to be input into the Phone Bill.

The reporting category 226 of FIG. 6 may relate to any information about the business that may be presented, such as capacity analysis 252, employee supply tracking 254, periodic capability reporting 256, unit cost by product/process 258, processing times 260, KIS scorecard 262, control charts 264, and other reports and presentation data.

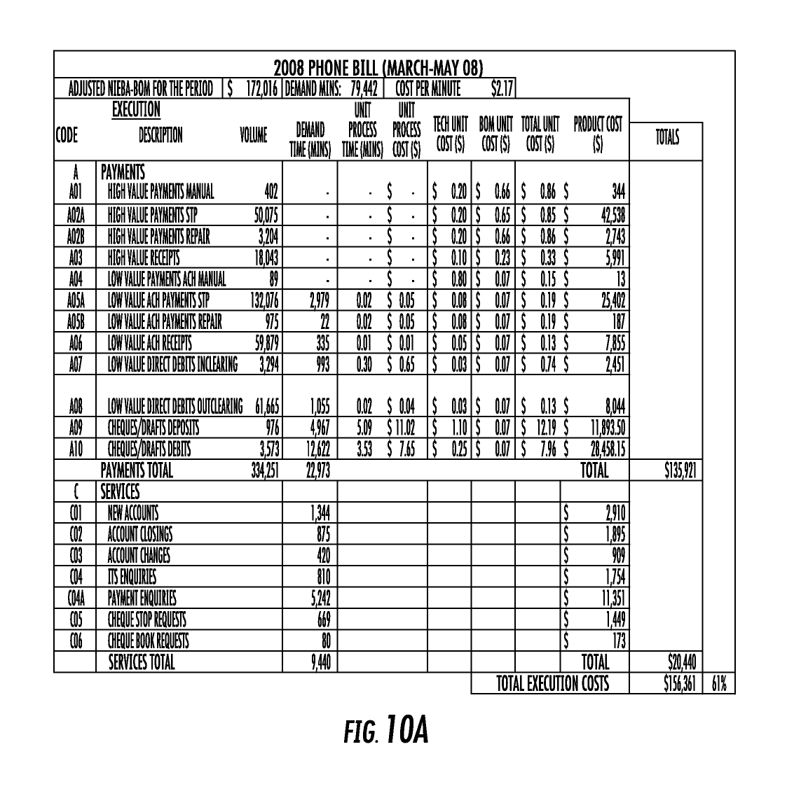

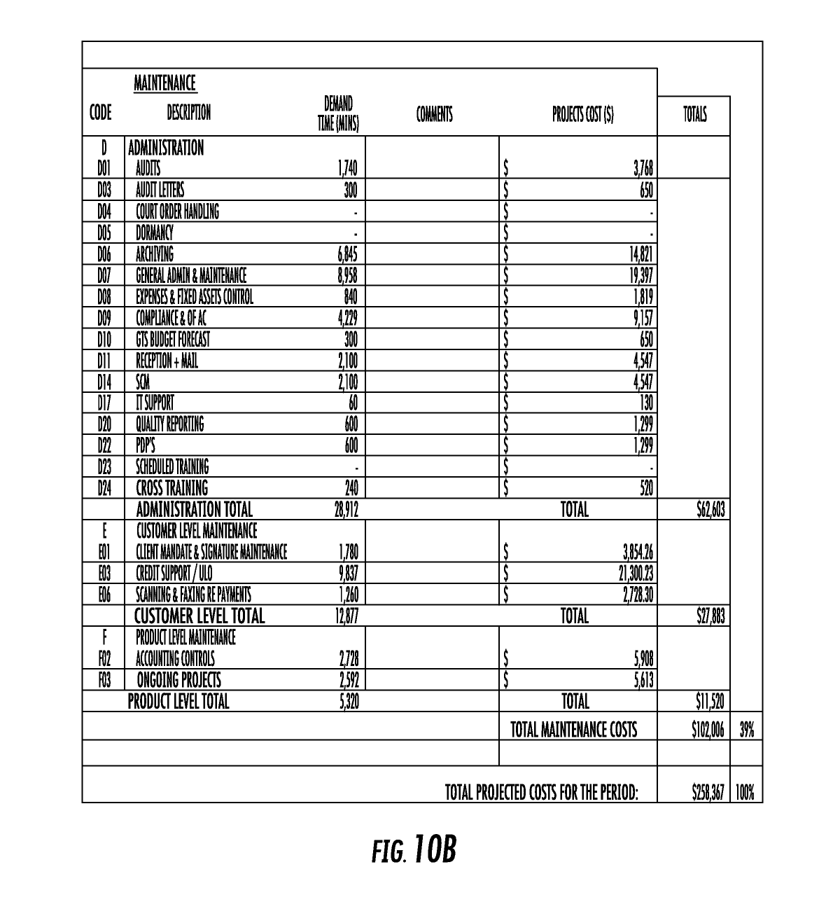

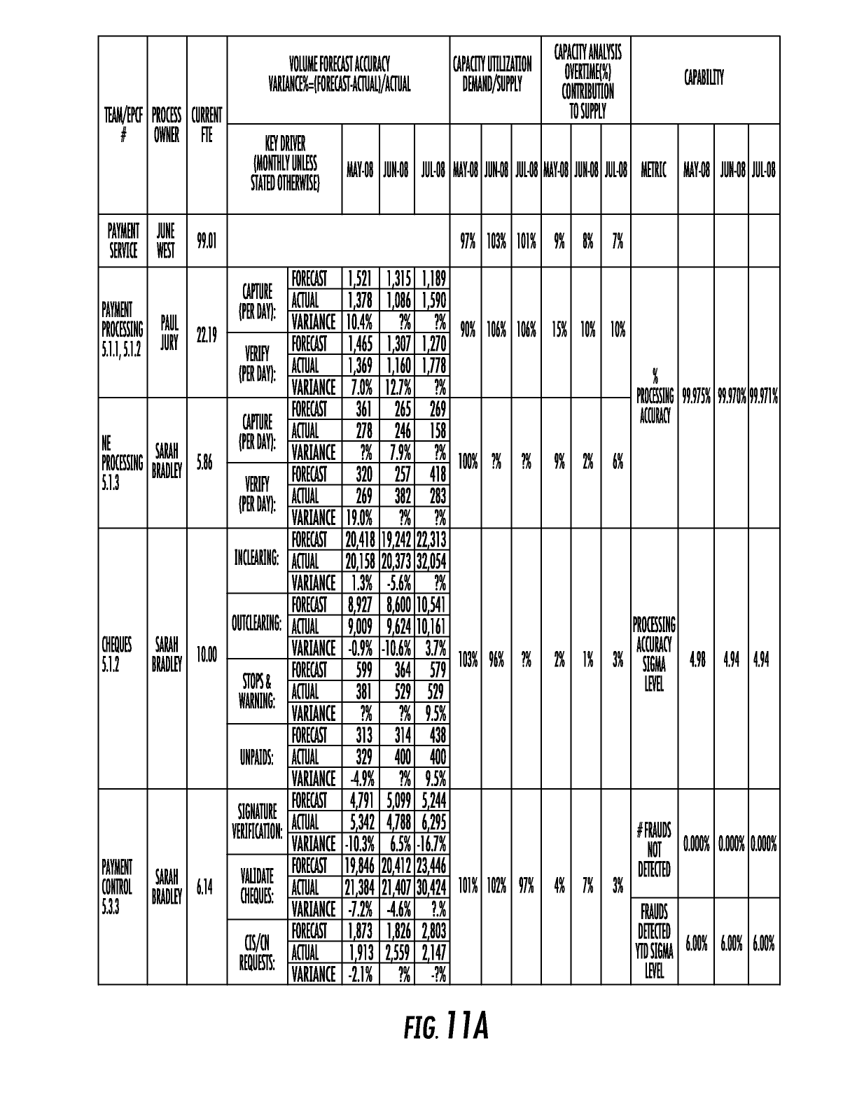

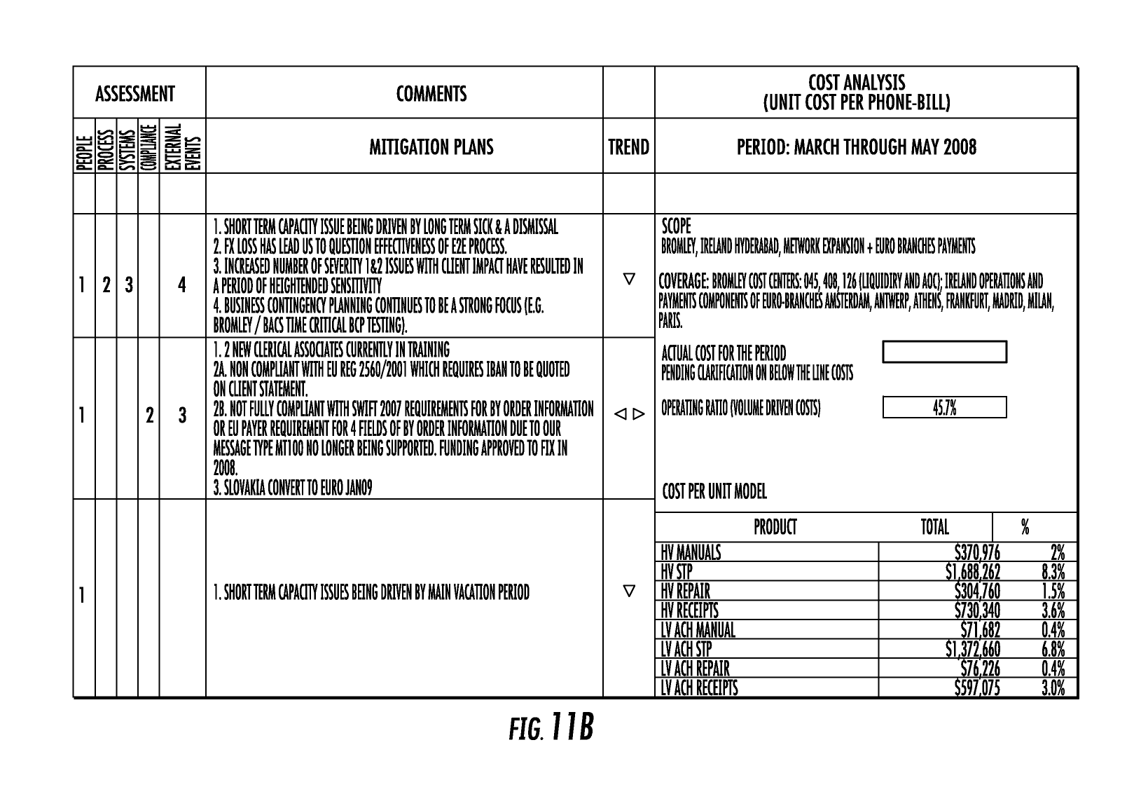

FIG. 7 is an example a FAT table 300 in accordance with an embodiment of the present invention. Generally, the FAT table 300 is a document owned by the financial institution that provides various information. For example, the FAT table 300 provides a complete view of all functions performed by the financial institution or to a portion of the business. The functions in the FAT table 300 are broken down at the team level and additionally records individual activities performed within each function. Activity volumes and timings for all the activities performed as also documented in the FAT table 300. This provides the amount of employee resource time required to support the business (“demand time”). The FAT table 300 may also provide employee resource details including full-time employee (FTE) volumes and attendance details (“supply time”). The FAT table 300 further provides an overall view of capacity based on the above-mentioned demand and supply time data. This capacity figure then becomes a key metric in assessing the ability to support the business. The FAT table 300 also provides value streams for all activities performed. Value streams indicate what value level is assigned to each activity, such as “value-added” for high value activities, “non-value added” for activities that have low value (or no value) to the business, etc. This enables management to differentiate between activities characterized as “value-added” (VA) and “non-value added” (NVA) activities. Analysis of the NVA steps may provide process improvement opportunities or productivity benefits. The FAT table 300 also provides for a summary view of capacity details and key metrics to be included in period-ending management reporting. This summary becomes the input for the KIS document. Details of the KIS are discussed later with regard to FIG. 11. The FAT table 300 further allows for a way of linking each business function to one or more of the business' core products, services or administration and maintenance functions. This enables the financial institution to calculate the associated aspects of the unit costs. Details of the Phone Bill are discussed later with respect to FIG. 10.

As previously mentioned, an exemplary FAT table 300 is illustrated in FIG. 7. The core products of the business are listed in the FAT table 300 and have various data associated with each product/process, including process flow, volumes, activity times and value streams. For example, the columns of FIG. 7 include data for “Functions,” “Activities,” “Volumes of Transaction Per Activity,” “Daily Minutes Per Activity,” “Daily Volume,” “Daily Time Per Volume,” “Value Stream,” “Activity Type,” and “Minutes Per Day Summary.” The “Functions” column lists all the functions performed by a specific team as part of the team's working days, months and/or year. The “Activities” column on the FAT table 300 lists all the activities at a reasonably high level that are involved in each of the functions. The “Volumes of Transaction Per Activity” column and “Daily Minutes Per Activity” column detail activity volumes per period (e.g., daily, weekly, monthly, etc.) and item times or total times that each activity takes (e.g., seconds, minutes, hours, etc.), respectively. The volume data may come from numerous existing reports or may be captured manually. The time data may come from time and motion studies; however, the time data may be approximated figures based on subject matter experts estimations. For the “Daily Volume” column and “Time Per Item/Min” column, the data from the “Transaction Volumes Per Activity” and “Daily Time Per Activity” columns are converted into equivalent daily volumes and item times. The “Value Added Determination” column identifies if the activities are value added (VA), non-value added (NVA), business value added (BVA) or risk value added (RVA). Reviewing NVA activities may provide process improvement opportunities. The “Activity Type” column advises whether the associated function is related to “Execution,” “Maintenance,” or “Growth” processes to determine if the process relates to execution of the process/product, maintenance of the business or process/product, or growth of the business, respectively. The “Minutes Per Day Summary” column is a multiple product of the “Daily Volume” column and the “Time Per Item/Min.” column. This indicates the daily resource demand minutes for each function.

In the FAT table 300, variable process volumes, timings, FTE levels and attendance details are updated by the business during a period (e.g., the current month) related to a previous period (e.g., the previous month). New functions and timings are added to the FAT table 300 and redundant functions are deleted. All changes to the FAT table 300 are verified for accuracy. Once the FAT table 300 has been verified and ensured total demand time matches the sum of the individual teams, then the final capacity data can be determined.

The FAT table 300 may also include a supply table 400. FIG. 8 is an example of a supply table 400 of the FAT table 300 in accordance with an embodiment of the present invention. The supply table 400 indicates team data relating to the team that performs the functions in the FAT table 300. As illustrated, the supply sheet 400 determines the “Net Total Supply Time” or the total amount of available work time. This may be accomplished using the following inputs illustrated in the supply sheet 400: “Number of Working Days,” “Number of Functional Associates,” “Number of Team Leads,” Percent Time in Production,” and data relating to overtime, vacation and sick leave. After determining the total supply time and a FAT demand time (discussed below), the “Net Capacity by Team” is determined by dividing the FAT demand time by the total supply time (demand/supply).

Thus, the FAT table 300 provides the demand minutes per unit of core product/process, calculated by cross referencing the activities of a plurality of employees across a plurality of different teams in the financial institution. Combining this with the break down of maintenance minutes by category allows for a determination of the unit cost in the Phone Bill. Additionally, by calculating demand and supply minutes across the plurality of teams, the employee workload capacity and capability of each team is determined. This provides management with accurate data that can be used to make decisions for a plurality of processes and not just a single focused process. This also enables studies to be carried out around employee resources in line with future business growth.

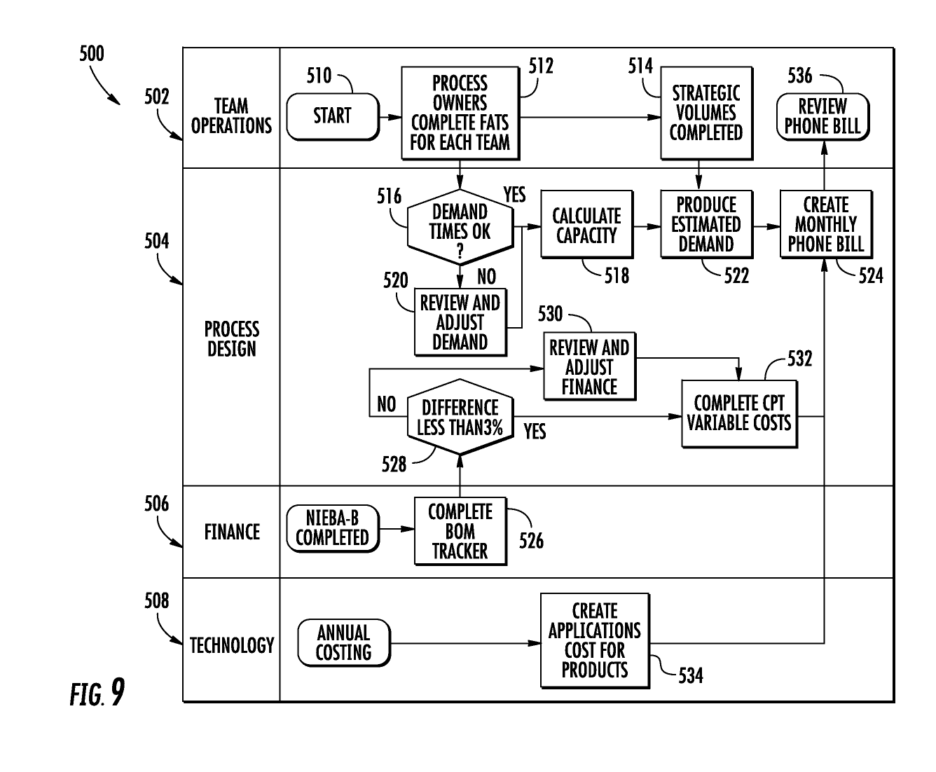

After determining the FAT table 300 along with the supply sheet 400, the Phone Bill may be developed. As previously discussed, the Phone Bill may be a complete view of all costs incurred to run the financial institution. The Phone Bill includes detailed information on the costs incurred by core products based on the resources utilized for fulfillment thereof. The Phone Bill provides an understanding of the cost drivers in terms of being either volume or non volume driven and also describes the types of costs as determined by activity-based costs of maintenance, execution or growth processes. The Phone Bill allows the financial institution to apply volume forecasts to the products that are volume driven (i.e., fulfilling products) vs. non-volume driven (administration, maintenance) and thus, allow the financial institution to obtain a better understanding of specific cost changes due to market changes in volume, process improvements, technology upgrades, etc. This will enable the financial institution to forecast and budget more accurately. The Phone Bill also provides information to consider when pricing the products and a probable market advantage in knowing the costs involved when tendering for new business opportunity, as well as aiding understanding of profitability information by product. Employee capacity and other costs are also detailed in the Phone Bill to provide an overview of the complete business across multiple divisions of the company in terms of various costs of the company, including costs related to product execution, maintenance, and growth. An example of a Phone Bill is illustrated in FIG. 10 and discussed below. Various information from the FAT and other sources are imported into an apparatus that generates the Phone Bill. A discussion of generating the Phone Bill is discussed below with regard to FIG. 9.

FIG. 9 is a flow chart 500 of an example of generating a Phone Bill in accordance with an embodiment of the present invention. As illustrated, at least four entities may act to implement these tasks, such as team operations 502, process design 504, finance 506, and technology 508. In accordance with embodiments of the present invention technology 508 may be discussed with determining technology costs of financial products, such as financial trades and the like. In such embodiments the apparatus, methods and computer program products shown and described in FIGS. 1-4 may be implemented.

At Event 510, the process 500 begins and proceeds to Event 512 where process owners complete a FAT table for each team. The FAT table was previously described above with regard to FIGS. 7-8. The output of Event 512 is sent to Event 514 and Decision 516. In Decision 516, a determination is made as to whether demand times in the FAT tables are acceptable. Such determination may be made based on criteria predefined by the financial institution. If the demand times in the FAT table are determined to be acceptable, the process 500 proceeds to Event 518; otherwise, the process 500 continues to Event 520.

At Event 520, if the demand time is not acceptable, the demand time and variables related thereto are reviewed and adjusted by the financial institution. After adjustments, the process 500 proceeds to Event 518. At Event 518, the employee capacity is calculated, as was previously described with regard to FIGS. 7-8. At Event 522, total estimated demand is produced by comparing the demand time with the employee capacity. This information provides the financial institution with data related to employee workloads, utilization, efficiency, etc. to determine if employee resources are being used efficiently and effectively. The total estimated demand is used to create the Phone Bill at Event 524. As such, the total estimated demand can be reviewed in the Phone Bill at Event 536.

At Event 526, a representative enters the vendor costs, also known as Bill of Material (BOM) costs, into a BOM Tracker spreadsheet for the month they are received. The BOM tracker spreadsheet is used to populate the Cost Per Unit (CPT) Variable worksheet for those costs that are volume driven and aligns them to the strategic volume for calculating Vendor Cost Per Unit (CPT). The Vendor Cost Per Unit is calculated using excel formulas to apply the cost to the volume. This may be accomplished by a Process Design employee.

At Event 528, one or more Process Design employees check the BOM figures against the budgeted financial figures to ensure there are no discrepancies above 3%. If there are discrepancies above 3%, the process 500 continues to Event 530 where the Process Design employee investigates with the vendor or invoice as to why the charges are different. The unit cost will be adjusted once the difference is understood and agreed to be an appropriate change.

At Event 532, the cost per transaction (CPT) costs are then calculated and then are used in creating the monthly Phone Bill at Event 524. Such information may then be viewed in the Phone Bill at Event 536.

At Event 534, the Technology group will annually provide the Process Design team with system technology-related costs (i.e., variable and fixed costs) and the costs tied back to the products the Technology group supports. Specifically, in accordance with present embodiments of the invention, technology-related costs related to financial products and, specifically financial trades, such as equity trades or the like, may be determined as described in relation to FIGS. 1-4 and provided to the design team.

With the above-described information, the Process Design team creates the Phone Bill which summarizes all costs by collating all of such information (Event 524). This is accomplished by each business region to compile the Phone Bill spanning multiple business groups. The operations team then reviews the Phone Bill at Event 536. An exemplary Phone Bill is described below.

FIG. 10 is an example a Phone Bill in accordance with an embodiment of the present invention. As illustrated, the Phone Bill has two sections, an Execution section and a Maintenance section. The Execution section of the Phone Bill relates to costs associated with execution of one or more processes, such as performing transactions for a product. The Maintenance section of the Phone Bill relates to costs associated with maintenance of products, such as employee training, administrative tasks, setting up products, audits, etc. It should be understood that other sections may also be included in the Phone Bill, such as a Growth section (not shown), which would relate to costs associated with growing the business by adding new products.

Referring first to the Execution section of the Phone Bill, listed are various core products involved in the internal functions and activities of the financial institution, such as “High Value Payments Manual,” “Low Value ACH Receipts,” etc. A volume and associated demand time is listed next to each process. It is noted that no demand figures are listed with some of the products. This is likely due to the process being automated such that no human demand time is required. Regardless, a unit process time, unit process cost, tech unit cost, and BOM unit cost associated with each process is also listed in the Phone Bill. The unit process time is calculated by dividing the demand time by the volume. The unit process cost is calculated by multiplying the unit process time a cost per minute which is inputted to the Phone Bill. The tech costs are costs associated with technology required to implement the process. The BOM costs are inputted vendor costs, as previously described. All of these costs are used in determining a total unit cost figure. The total unit cost figure is calculated by summing the unit process cost, the tech unit cost and the BOM unit cost. The process/product cost is then calculated by multiplying the total unit cost by the volume. This is the total cost associated with the listed process/product. After determining the costs for each core process/product, all of the process/product costs for the Execution section are summed and displayed as a total cost. As illustrated in FIG. 10, the Execution section is shown as separated into a “Payments” section and a “Services” section. This is only to separate the volume driven costs and the non-volume driven costs. The non-volume driven costs are determined by multiplying the demand time by the unit costs.

After determining the total costs for all products, both volume-driven and non-volume driven, for the Execution section, a total Execution cost is calculated. The Execution costs relate to costs associated with executing various products of the financial institutions.

In addition to the Execution costs, costs associated with the Maintenance section are determined using a similar process described above for the Execution costs. The maintenance costs relate to costs associated with maintaining products, such as audits, compliance activities, IT support, etc. After determining the total costs for all sections (e.g., Execution, Maintenance, etc.), a total projected cost for the period is obtained by summing the total costs of all sections. This information is associated across a plurality of business groups of the financial institution. In one embodiment, the Phone Bill includes costs spread across all business groups of the financial institution.

The information from the Phone Bill is imported into the KIS. FIGS. 11A and 11B (collectively FIG. 11) is an example of a key indicator scorecard (KIS) in accordance with an embodiment of the present invention. The KIS provides a “one-stop-shop” for all metrics data deemed as key in making business decisions. The data is collated showing a rolling view of team details, key volume trends (forecast vs. actual) across the different teams, team capacity figures, other capacity figures, risk figures and commentary and other information. The team details include process owners and full-time employee (FTE) levels. The team capacity figures identify the ability to handle current workloads as well as absorb additional work. Other capability figures identify how well the business is operating in relation to various goals and targets. Risk figures and commentary includes mitigation plans, action steps and trending information.

The KIS document enables the financial institution to view volume, capacity, capability and control data in one place. The KIS captures a rolling view over a specified period, such as over a three month period. The data allows management to assess current state, and allows for comments to be added around mitigation plans and action steps.

As illustrated in FIG. 11, the KIS illustrates various data associated with teams of the financial institution, where each team has a process owner. The first data presented is number of current full-time employees associated with each respective team.

The second set of data in FIG. 11 is the “Volume Forecast Accuracy” which is separated into data associated with a plurality of key drivers. With each key driver, forecasted data is compared with actual data and a variance thereof is presented for each period (e.g., month). The forecasted volume is based on a daily average volume from the previous period so that variation in the number of working days from one period to the next does not impact the outcome. The variance is calculated by dividing the difference between the forecasted data and the actual data by the actual data. As illustrated, the variance data may be placed in different categories, such as 0-10%, 10%-20%, and more than 20%. The volume forecast information illustrates a rolling three month snapshot.

The third set of data in FIG. 11 is under “Capacity Utilization,” where for each period (e.g., month), a percentage of the demand over supply. This determines how much employee time is required over how much employee capacity is available. For example, a capacity utilization of 123% means that there is not enough employee utilization to achieve what needs to be done for execution, maintenance and growth of the core products and the financial institution. Conversely, a capacity utilization of 90% indicates that the employee time is higher than what is needed and thus can be adjusted to areas where employee resources are needed. Ideally, the scope of capacity utilization would be approximately 90% so that employees are able to absorb additional volume and deal with short term challenges, typically relating to external events or market conditions.

The fourth set of data in FIG. 11 is under “Capacity Analysis,” indicating an overtime contribution percentage for each period. Such information provides data reflecting overtime worked by employees as a percentage of the employee supply time. This metric may provide overtime cost and employee morale information.

The fifth set of data in FIG. 11 is under “Capability,” which provides various data of accuracy for each period. For example, accuracy data is provided for each capability metric, such as percent processing accuracy, processing accuracy sigma level, number of frauds detected, frauds detected year-to-date sigma level, etc. This provides information to determine how well each process/product is being executed.

In the sixth column in FIG. 11 under “Assessment” includes inputted thoughts based on what the data in the KIS means to a manager at the financial institution. Various categories may be included, such as people, process, systems, compliance, external events, etc. Thus, a manager can review the core products in terms of volumes, capacity, capability and capacity to input manually determined scores in each of the various categories. These scores relate to the comments in the KIS, discussed below.

In the “Comments” column of the KIS allows management to provide any comments based on the data in the KIS, such as actions, mitigation plans, etc. These comments may then be provided to team members and discussed to implement any possible mitigation plans or other actions.

The “Cost Analysis” column of the KIS relates to other generic metrics required on a periodic basis. This data originates from elsewhere but are captured as part of a summary of the KIS. In one embodiment, this data is automatically fed from the Phone Bill.

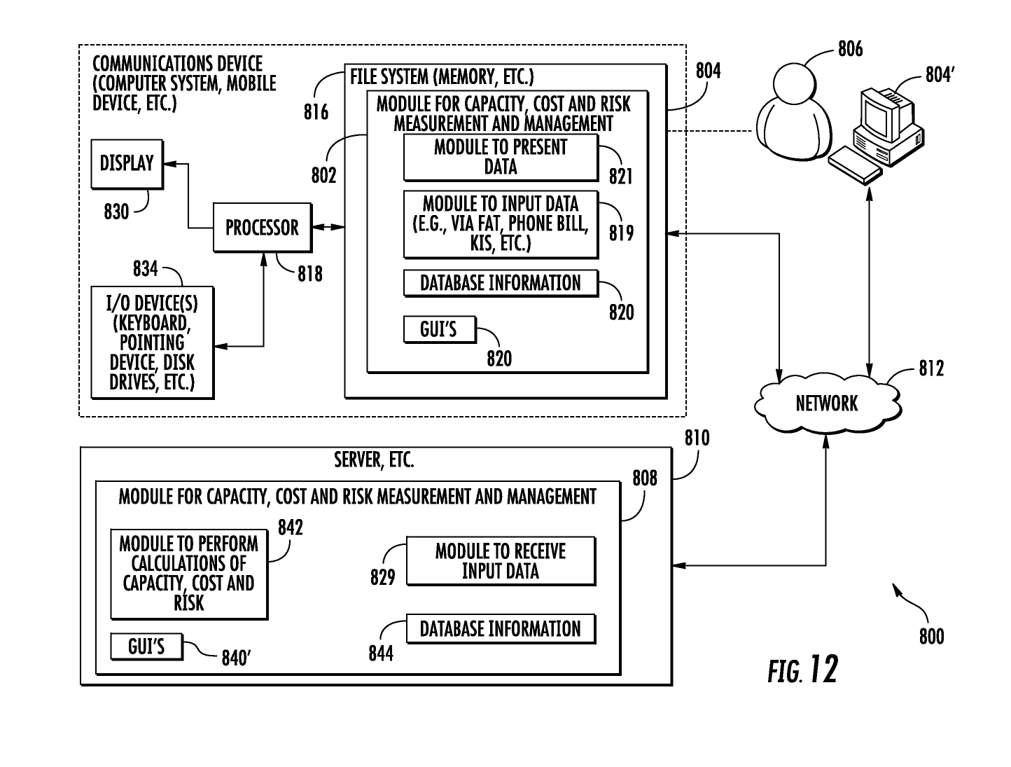

FIG. 12 is a block schematic diagram of an example of an apparatus for managing business rigor in accordance with an embodiment of the present invention. The system 800 includes a module for business rigor management 802 operable on a computer system 804 or similar device of a user 806 or a client. In addition to the module for business rigor management 802 on the user's computer system 804 or client, the system 800 includes a module for business rigor management 808 operable on a server 810 and accessible by the user 806 or client 804 via a network 812. The methods 150, 200 and 500 are embodied or performed by the module for business rigor management 802 or the server module for business rigor management 808. For example, the methods 150, 200 and 500 may be performed by the module for business rigor management 802. In another embodiment of the invention, the methods 150, 200 and 500 are performed by the server module for business rigor management 808. In a further embodiment of the present invention, some of the features or functions of the methods 150, 200 and 500 are performed by the module for business rigor management 802 on the user's computer system 804 and other features or functions of the methods 150, 200 and 500 are performed on the server module for business rigor management 808.

The network 812 is the Internet, a private network or other network as previously mentioned. Each computer system 804′ is similar to the exemplary computer system 804 and associated components as illustrated in FIG. 12.

The module for business rigor management 802 and/or 808 is a self contained system with imbedded logic, decision making, state based operations and other functions to measure and manage business rigor for capacity, cost and risk.

The module for business rigor management 802 is stored on a file system 816 or memory of a computer system 804. The module for business rigor management 802 may be accessed from the file system 816 and run on a processor 818 associated with the computer system 804.

The module for business rigor management 802 includes a module to input data 819. The module to input data 819 allows entry of various metrics information into the system 300, such as volume, capacity data, employee information, core products, cost information, target information, and any other desired information. The inputted information may be related to one or more or all business groups within a company or financial institution. In one embodiment, the inputted information may be sent for processing or direct automatically inputted into the FAT, Phone Bill or KIS. The module to input data 819 is accessed or activated whenever the user 806 desires to input information, including various metric information or other information, and calls other modules such as the graphical user interface 840, as described below. The input of business rigor information is received by the module to receive input data 829 on the server 810 via the network 812.

The server module for business rigor management 808 also includes database information 820. The database information 820 includes any stored information related to the metrics of the financial institution, such as core products volumes, cost information, employee volumes, capacity, capabilities, and any other information associated with business rigor. The database information 820 may serve as a location to store various information from period to period, such as on a monthly basis. The database information 820 may further store processed data for archiving and for future reference or access. The database information 820 may be stored in a database (not shown) resident on the server and/or locally on one or more computers.

The module for business rigor management 802 also includes a module to present data 821. The module to present data 821 presents the FAT, Phone Bill, KIS and/or other information to the user 306. In addition to presenting the FAT table, Phone Bill and KIS, the module to present data 821 may create reports, templates, and/or other data for use by the user 306, future processing, or for other purposes. The module to present data 821 works in concert with the graphical user interface 340 to present the information on an output device (discussed below), store data in the file system 316 or database information 320, and the like.

The user's computer system 804 includes a display 830. Any presentation data and/or any graphical user interfaces 840 associated with the module for business rigor management 808 may be presented on the display 830. The user's computer system 804 also includes one or more input devices, output devices or combination input and output devices, collectively I/O devices 834. The I/O devices 834 may include a keyboard, computer pointing device, touch screen, touch pad, or similar devices to control input of information as described herein. The I/O devices 834 also include disk drives or devices for reading computer media including computer readable or computer operable instructions.

The server module for business rigor management 808 includes a module to receive input data 829. As previously discussed, the module to receive input data 829 receives inputted data from the module to input data 319 and/or database information 320, 344 from a database (not shown). After receiving any input data or database information, the module to receive input data 829 transmits the data to one or more modules on the server 310 or computer 304. The module to receive input data 829 may perform other operations such as communicating with other modules on the server 310 and transmitting any information received there from to one or more of the user's computers 304.

The server module for business rigor management 808 includes a module to perform calculations of capacity, cost, and risk 842. The module to perform calculations of capacity, cost, and risk 342 performs various functions, such as developing portions of the FAT, Phone Bill and KIS, and performing other processing and calculations of data in the system. The module to perform calculations of capacity, cost, and risk 342 receives predefined criteria to perform such data processing.

The server module for business rigor management 808 also includes database information 844. The database information 844 is similar to the database information 820 of the user's computer 304, previously discussed. For example, database information 844 includes any stored information related to the metrics of the financial institution, such as core products volumes, cost information, employee volumes, capacity, capabilities, and any other information associated with business rigor.

The module for business rigor management 802, 808 includes graphical user interfaces 840, 840′, as previously mentioned. The module for business rigor management 802, 808 allows one or more predetermined graphical user interfaces 840 to be presented to the user 806 in order for the user 806 to input data or information into the system 800. The graphical user interfaces 840 are predetermined and/or presented in response to the user 806 indicating the user 806 would like to perform a task, such as requesting input information, requesting other information, inputting information, presenting information to the user 306 and financial institution, etc. The predetermined graphical user interfaces 840 are generated by the module for business rigor management 802, 808 and are presented on the display 830 at the computer system 804. Graphical user interfaces 840 also include graphical user interfaces that permit the user 806 to view the FAT, Phone Bill and KIS and query any of the databases and/or generate reports and/or standardize documents.

Thus, present embodiments, described below in further detail, provides for determining cost, specifically, technology application costs associated with a financial product, such as equity trades. The cost determining model herein described determines cost for all technology processes and applications across the entire equity trade, including front end, operations, middle office, front-to-back end (e.g., trade capture, documentation, settlement, finance and the like). As such, the determined cost provides a complete picture of the economic impact of the equity trade. In addition the costing model herein described is capable of aligning with a comprehensive corporation or enterprise-wide system that determines and manages costs and/or business rigor.

The flowcharts and block diagrams in the Figures illustrate the architecture, functionality, and operation of possible implementations of systems, methods and computer program products according to various embodiments of the present invention. In this regard, each event in the flowchart or block in a block diagram may represent a module, segment, or portion of code, which comprises one or more executable instructions for implementing the specified logical function(s). It should also be noted that, in some alternative implementations, the functions noted in the block/event may occur out of the order noted in the Figures. For example, functions repeated by the two blocks/events shown in succession may, in fact, be executed substantially concurrently, or the functions noted in the blocks/events may sometimes be executed in the reverse order, depending upon the functionality involved. It will also be noted that each block of the block diagrams and/or event in the flowchart illustration, and combinations of blocks in the block diagrams and/or events in the flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention, unless the context clearly indicates otherwise. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for determining per-process technology application cost for a financial product, the method comprising:
identifying a plurality of processes and a plurality of technology applications each of which are associated with a financial product;
determining process allocation percentages for each of the identified technology applications and processes associated with each of the technology applications;
determining, via a computing device processor, a per-financial product technology cost for each of the plurality of technology applications over a predetermined time period; and
determining, via a computing device processor, the per-process technology application cost for the financial product based on the per-financial product technology cost for each of the plurality of technology applications and the process allocation percentages associated with a respective process and a respective technology application.

2. The method of claim 1, wherein the financial product further comprises a financial trade product.

3. The method of claim 2, wherein the financial trade product further comprises an equity trade product.

4. The method of claim 1, wherein determining process allocation percentages further comprises mapping the plurality of processes to each of the plurality of technology applications to assess the process allocation percentages.

5. The method of claim 1, wherein determining the per-financial product technology cost further comprises determining a total technology cost for each of the plurality of technology applications, wherein the total technology cost for each of the plurality of technology applications accounts for entity-wide costs.

6. The method of claim 5, wherein determining the total technology cost further comprises receiving core costs, administrative costs and infrastructure costs for each of the plurality of technology applications and summing the core costs, administrative costs and infrastructure costs to result in the total technology cost for each of the plurality of technology applications.

7. The method of claim 1, wherein determining the per-financial product technology cost further comprises determining the per-financial product technology cost based on a financial product allocation percentage associated with a respective financial product and one of the technology applications.

8. The method of claim 5, wherein determining the per-financial product technology cost further comprises calculating, via the computing device processor, the per-financial product technology cost for each technology application by multiplying the total technology cost for each of the plurality of technology applications by a financial product allocation percentage associated with a respective financial product.

9. The method of claim 1, wherein determining per-process technology cost further comprises calculating, via the computing device processor, a per-process technology cost by multiplying the per-financial product technology cost for each of the plurality of technology applications by the process allocation percentage associated with the process and the technology application.

10. The method of claim 1, further comprising determining, via a computing device processor, a volume of financial products occurring over the predetermined time period.

11. The method of claim 10, further comprising determining, via a computing device processor, a financial product technology unit cost based on the volume.

12. The method of claim 10, further comprising determining, via a computing device processor, a per-process technology cost per financial product unit based on the volume.

13. The method of claim 12, wherein determining per-process technology cost per financial product unit further comprises calculating the per-process technology cost per financial product unit by dividing the per-process technology cost by the volume.

14. An apparatus for determining per-process technology cost for a financial product, the method comprising:
a computing platform including at least one processor and a memory; and
a financial product technology cost determining module stored in the memory, executable by the processor and including,
a technology cost determining routine configured to determine a per-financial product technology cost for each of a plurality of technology applications, wherein the per-financial product technology cost is incurred over a predetermined time period, and
a per-process technology cost determining routine configured to determine, the per-process technology cost for the financial product based on the per-financial product technology cost for each of the plurality of technology applications and a process allocation percentage associated with a respective process and one of the technology applications.

15. The apparatus of claim 14, wherein the financial product further comprises a financial trade product.

16. The apparatus of claim 15, wherein the financial trade product further comprises an equity trade product.

17. The apparatus of claim 14, wherein the technology cost determining routine is further configured to determine a total technology cost for each of the plurality of technology applications, wherein the total technology cost for each of the plurality of technology applications accounts for entity-wide costs.

18. The apparatus of claim 17, wherein the technology cost determining routine is further configured to receive core costs, administrative costs and infrastructure costs for each of the plurality of technology applications and sum the core costs, administrative costs and infrastructure costs to result in the total technology cost for each of the plurality of technology applications.

19. The apparatus of claim 14, wherein the technology cost determining routine is further configured to determine the per-financial product technology cost based on a financial product allocation percentage associated with a respective financial product and one of the technology applications.

20. The apparatus of claim 17, wherein the technology cost determining routine is further configured to calculate the per-financial product technology cost for each technology application by multiplying the total technology cost for each of the plurality of technology applications by a financial product allocation percentage associated with a respective financial product and a respective technology application.

21. The apparatus of claim 14, wherein the per-process technology cost determining routine is further configured to calculate the per-process technology cost by multiplying the per-financial product technology cost for each of the plurality of technology applications by the process allocation percentage associated with a respective financial product process and one of the technology applications.

22. The apparatus of claim 14, wherein the financial product technology cost determining module further comprises a financial product unit cost determining routine configured to determine financial product unit technology cost based on a volume of financial products occurring over the predetermined time period.

23. The apparatus of claim 22, wherein the financial product unit cost determining routine if further configured to determine per-process technology cost per financial product unit.

24. The apparatus of claim 23, wherein the financial product unit cost determining routine is further configured to calculate per-process technology cost per financial product unit by dividing the per-process technology cost by the volume of financial products occurring over the predetermined time period.

25. A computer program product comprising:
a non-transitory computer-readable medium comprising:
a first set of codes for causing a computer to determine a per-financial product technology cost for each of a plurality of technology applications associated with a financial product, wherein the per-financial product technology cost is over a predetermined period of time; and
a second set of codes for causing a computer to determine a per-process technology cost for the financial product based on the per-financial product technology cost for each of the plurality of technology applications and process allocation percentages associated with a respective process and a respective technology application.

26. The computer program product of claim 25, wherein the financial product further comprises a financial trade product.

27. The computer program product of claim 26, wherein the financial trade product further comprises an equity trade product.

28. The computer program product of claim 21, wherein the first set of codes is further configured to cause the computer to determine a total technology cost for each of the plurality of technology applications, wherein the total technology cost for each of the plurality of technology applications accounts for entity-wide costs.

29. The computer program product of claim 28, wherein the first set of codes is further configured to cause the computer to receive core costs, administrative costs and infrastructure costs for each of the plurality of technology applications and sum the core costs, administrative costs and infrastructure costs to result in the total technology cost for each of the plurality of technology applications.

30. The computer program product of claim 24, wherein the first set of codes is further configured to cause the computer to determine the per-financial product technology cost based on financial product allocation percentages associated with a respective financial product and one of the technology applications.

31. The computer program product of claim 28, wherein the first set of codes is further configured to cause the computer to calculate the per-financial product technology cost for each technology application by multiplying the total technology cost for each of the plurality of technology applications by a financial product allocation percentage associated with a respective financial product.

32. The computer program product of claim 25, wherein the second set of codes is further configured to cause the computer to calculate the per-process technology cost by multiplying the per-financial product technology cost for each of the plurality of technology applications by the process allocation percentage associated with the process and the technology application.

33. The computer program product of claim 25, further comprising a third set of codes for causing a computer to determine a volume of financial products occurring over the predetermined time period.

34. The computer program product of claim 33, further comprising a fourth set of codes for causing a computer to determine a financial product technology unit cost based on the volume.

35. The computer program product of claim 33, further comprising a fourth set of codes for causing a computer to determine a per-process technology cost per financial product unit based on the volume.

36. The computer program product of claim 35, wherein the fourth set of codes is further configured to cause the computer to calculate the per-process technology cost per financial product unit by dividing the per-process technology cost by the volume.
